(19) United States
(12) Patent Application Publication
(10) Pub. No.: US 2012/0057435 A1
(43) Pub. Date: Mar. 8, 2012

(54) Drive control apparatus, timepiece apparatus, and electronic apparatus

(76) Inventors: Keishi Honmura, Chiba-shi (JP); Takanori Hasegawa, Chiba-shi (JP); Akira Takakura, Chiba-shi (JP); Kenji Ogasawara, Chiba-shi (JP); Kazumi Sakumoto, Chiba-shi (JP); Hiroshi Shimizu, Chiba-shi (JP); Saburo Manaka, Chiba-shi (JP); Kosuke Yamamoto, Chiba-shi (JP)

(21) Appl. No.: 13/199,495

(22) Filed: Aug. 31, 2011

(30) Foreign Application Priority Data
Sep. 8, 2010 (JP) 2010-201121
Jun. 21, 2011 (JP) 2011-137041

(51) Int. Cl. H02P 8/38; G04C 3/14

(52) U.S. Cl. 368/76; 318/696

(57) ABSTRACT

The invention is intended to allow a motor to be driven normally even when an output voltage of a primary power source unit varies. A motor drive control unit configured to attenuate a charge of a secondary cell by an electromotive force of a solar cell to a level lower than the charge at that moment before driving the motor, and then intensify the charge of a level higher than the charge at that moment after having driven the motor is provided.

### BACKGROUND OF THE INVENTION

1. Technical Field

The present invention relates to a drive control apparatus, a timepiece apparatus, and an electronic apparatus.

2. Description of the Related Art

In recent years, electronic apparatuses such as timepieces or calculators which employ a photoelectric conversion unit (solar cell) configured to convert light energy to electric energy or a generating set configured to convert kinetic energy in association with the movement of a user into electric energy as a primary power source unit are widely used. As an example of the electronic timepieces, an analogue electronic timepiece configured to charge a secondary cell (secondary power source unit) by a voltage generated by a primary power source unit, output a motor drive pulse from a timepiece circuit using charged energy in the secondary cell, and rotate a rotor for bringing hands into motion is known (for example, see JP-A-7-306274 and JP-A-7-294670).

However, in the case of the electronic apparatuses in the related art such as electronic timepieces described in JP-A-7-306274 and JP-A-7-294670, if an output voltage of the solar cell (primary power source unit) varies when driving a motor for moving hands, a power supply voltage suddenly changes, and hence the motor may lose normal rotation. In addition, in the electronic apparatuses in the related art, if the power supply voltage suddenly changes, erroneous detection may be resulted when detecting the fact that the motor rotates normally. Consequently, a motion error which hinders accurate time measurement may occur. In this manner, the electronic apparatuses in the related art have a drawback in that variations in output voltage of the solar cell may lose a normal driving of the motor.

### SUMMARY OF THE INVENTION

It is an aspect of the present application to provide a drive control apparatus, a timepiece apparatus and an electronic apparatus configured to be capable of rotating a motor normally even when an output voltage of a primary power source unit is varied.

According to another aspect of the application, there is provided a drive control apparatus including a motor drive control unit comprising a motor drive control unit configured to attenuate a charge of a secondary power source unit by an electromotive force of a primary power source unit while a motor is driven in comparison with a case where the motor is not driven.

Preferably, a period when the charge is attenuated by the motor drive control unit is a main drive pulse generating period of the motor.

Preferably, the drive control apparatus includes a rotation detection unit configured to detect the rotation of the motor, and the period when the charge is attenuated by the motor drive control unit includes the main drive pulse generating period of the motor and the period from the start of detection of the rotation of the motor by the rotation detection unit until the rotation of the motor is detected.

Preferably, the intensification of the charge by the motor drive control unit is performed when the rotation is detected by the rotation detection unit.

Preferably, the intensification of the charge by the motor drive control unit is performed when the rotation of the motor is not detected by the rotation detection unit within a predetermined period.

Preferably, the drive control apparatus includes a magnetic field detection unit configured to detect a magnetic field received by the drive control apparatus, and the intensification of the charge by the motor drive control unit is performed when the detected magnetic field is stronger than a predetermined magnetic field.

Preferably, the drive control apparatus includes a cell voltage detection unit configured to detect the voltage of the secondary power source unit, and the intensification of the charge by the motor drive control unit is performed when the detected voltage is equal to or lower than the predetermined voltage.

Preferably, the intensification of the charge by the motor drive control unit is performed when the drive is translated to a fixed pulse drive.

Preferably, the drive control apparatus includes a charge-stop unit configured to stop the charge of the secondary power source unit, and the motor drive control unit causes the charge-stop unit to stop the charge of the secondary power source unit before driving the motor and gives permission to start the charge after having driven the motor.

Preferably, the charge-stop unit includes an overcharge protecting unit configured to stop the charge of the secondary power source unit when an output potential difference of the primary power source unit is equal to or larger than a predetermined threshold value.

Preferably, the charge-stop unit includes a backflow preventing unit configured to stop the charge of the secondary power source unit when the output potential difference of the primary power source unit is equal to or smaller than an output potential difference of the secondary power source unit.

Preferably, the charge-stop unit brings the connection between an anode terminal of the secondary power source unit and an anode terminal of the primary power source unit or the connection between a cathode terminal of the secondary power source unit and a cathode terminal of the primary power source unit into a non-conducting state when stopping the charge of the secondary power source unit.

Preferably, the drive control apparatus includes the backflow preventing unit configured to bring the connection between the anode terminal of the secondary power source unit and the anode terminal of the primary power source unit or the connection between the cathode terminal of the secondary power source unit and the cathode terminal of the primary power source unit into a non-conducting state when the output potential difference of the primary power source unit is equal to or lower than the output potential difference of the secondary power source unit, and the charge-stop unit is configured to bring the connection between the anode terminal of the primary power source unit and the cathode terminal of the primary power source unit into a conducting state when stopping the charge of the secondary power source unit.

Preferably, the secondary power source unit is a solar cell.

Preferably, the motor is a time-of-day motor configured to measure the time.

According to another aspect of the application, there is provided a timepiece apparatus including the drive control apparatus described above.

According to another aspect of the application, there is provided an electric apparatus comprising the drive control apparatus described above.

According to the application, the charge of the secondary power source unit (for example, the secondary cell) by the primary power source unit (for example, the solar cell) is stopped before starting driving of the motor to prevent the voltage of the power source configured to supply an electric power from changing during the driving of the motor. Accordingly the motor can be driven normally even when the output voltage of the primary power source unit varies.

### BRIEF DESCRIPTION OF THE DRAWINGS

FIG. 1 is a schematic block diagram showing a timepiece apparatus according to a first embodiment of the invention;

FIG. 2 is a flowchart showing an operation of the timepiece apparatus in the first embodiment;

FIG. 3 is a schematic block diagram showing a timepiece apparatus according to a second embodiment of the invention;

FIG. 4 is a schematic block diagram showing a configuration of an overcharge protecting unit 20a in the second embodiment;

FIG. 5 is a flowchart showing an operation of the timepiece apparatus in the second embodiment;

FIG. 6 is a schematic block diagram showing a timepiece apparatus according to a third embodiment of the invention;

FIG. 7 is explanatory drawing showing an example of a process of intensifying a charge when a motor drive control unit determines that a motor is rotating;

FIG. 8 is explanatory drawing showing an example of a process of intensifying the charge when the motor drive control unit determines that the motor is not rotating;

FIG. 9 is explanatory drawing showing an example of a process of intensifying the charge when the motor drive control unit determines that a magnetic field is detected;

FIG. 10 is explanatory drawing showing an example of a process of intensifying the charge by the motor drive control unit when the voltage of a secondary cell is lowered; and

FIG. 11 is a flowchart showing an example of an operation of a motor drive control unit 5b in the third embodiment.

### DESCRIPTION OF THE PREFERRED EMBODIMENTS

### First Embodiment

Referring now to the drawings, an electronic apparatus (for example, a timepiece apparatus) according to a first embodiment of the invention will be described.

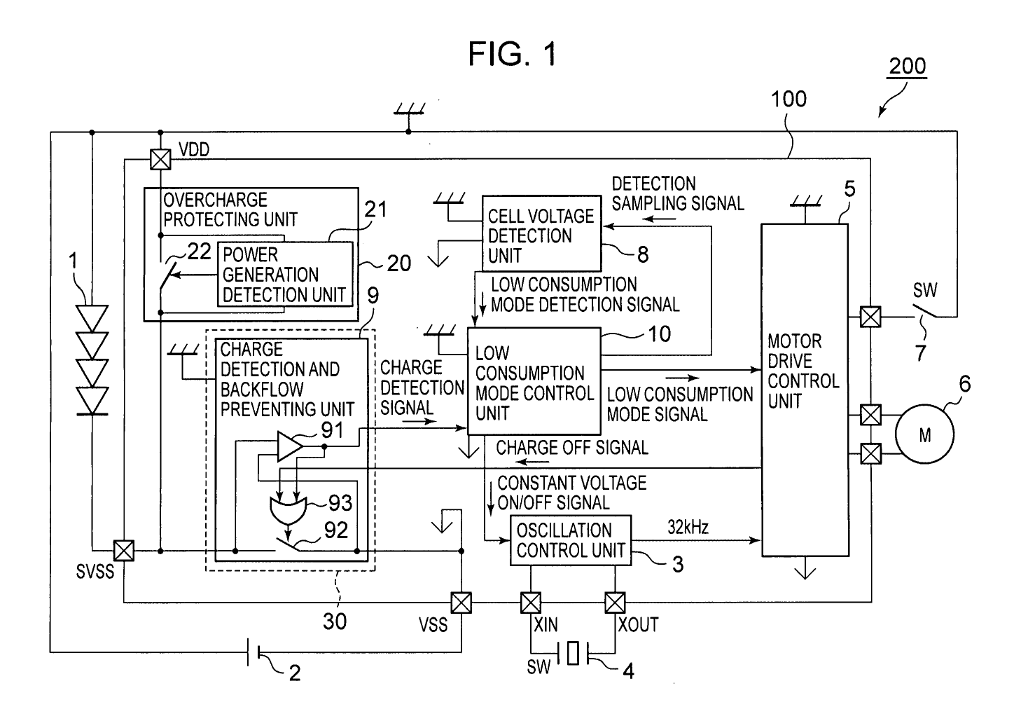

FIG. 1 is a schematic block diagram showing the timepiece apparatus (hereinafter, referred to as timepiece) according to the first embodiment of the invention.

In FIG. 1, a timepiece 200 includes a solar cell 1, a secondary cell 2, a crystal oscillator 4, a motor 6 for time-of-day (for bringing hands into motion), a switch (SW) 7, and a drive control unit 100. The drive control unit 100 includes an oscillation control unit 3, a motor drive control unit 5, a cell voltage detection unit 8, a charge detection and backflow preventing unit 9, a low consumption mode control unit 10, and an overcharge protecting unit 20. The timepiece 200 is an analogue-display-type electronic timepiece, for example, and the motor 6 for bringing the hands into motion is a step motor.

In the timepiece 200, the charge detection and backflow preventing unit 9 in the drive control unit 100 is included in a charge-stop unit 30.

Referring now to FIG. 1, functions of respective parts in the timepiece 200 will be described in sequence.

An anode terminal of the solar cell 1 (primary power source unit) is connected to a power source line VDD and a cathode terminal thereof is connected to a power source line SVSS. The cathode terminal of the solar cell 1 is connected to the charge detection and backflow preventing unit 9. The solar cell 1 generates an electromotive force by light. The solar cell 1 charges the secondary cell 2 via the charge detection and backflow preventing unit 9. The solar cell 1 supplies an electric power to the respective parts of the timepiece 200 via the power source line VDD. The power source line VDD here is a VDD ground, and represents a reference potential of the entire timepiece 200.

An anode terminal of the secondary cell 2 (secondary power source unit) is connected to a power source VDD and a cathode terminal thereof is connected to the power source VSS. The cathode terminal of the secondary cell 2 is connected to the charge detection and backflow preventing unit 9. The secondary cell 2 is charged by the electromotive force of the solar cell 1 via the charge detection and backflow preventing unit 9. The secondary cell 2 supplies an electric power to the respective parts of the timepiece 200 via the power source line VDD.

The oscillation control unit 3 is connected to the crystal oscillator 4, and oscillates and generates a basic clock signal used for measurement of time of day. The oscillation control unit 3 controls an oscillating operation of the basic clock signal on the basis of a constant voltage ON/OFF signal supplied from the low consumption mode control unit 10. Here, for example, when the constant voltage ON/OFF signal is a “H (high)” state, the oscillation control unit 3 stops an oscillation of the basic clock signal. Also, for example, when the constant voltage ON/OFF signal is an “L (LOW)” state, the oscillation control unit 3 oscillates the basic clock signal.

The oscillation control unit 3 supplies the generated basic clock signal to the motor drive control unit 5. The frequency of the basic clock signal generated by the oscillation control unit 3 is, for example, 32.768 kHz (kilohertz). The crystal oscillator 4 is connected to the oscillation control unit 3, and is used for oscillating the basic clock signal.

The motor drive control unit 5 controls the time measuring operation to measure the time of day on the basis of the basic clock signal supplied from the oscillation control unit 3. The time measuring operation includes an operation to drive the motor (M) 6 that brings the hands of the timepiece 200, which indicates the time of day, into motion. In other words, the motor drive control unit 5 is connected to the motor 6 and controls driving of the motor 6. The motor drive control unit 5 translates the timepiece 200 to a low consumption mode on the basis of a low consumption mode signal supplied from the low consumption mode control unit 10. More specifically, when the low consumption mode signal is in the “H” state, the motor drive control unit 5 translates the timepiece 200 to the low consumption mode. When the low consumption mode signal is in the “L” state, the motor drive control unit 5 translates the timepiece 200 from the low consumption mode to a normal operation mode. The motor drive control unit 5 is connected to one end of the switch (SW) 7 and, on the basis of the state of the switch 7, stops or starts the driving the motor 6.

The motor drive control unit 5 brings a charge OFF signal to the “H” state to output the same to the charge-stop unit 30 (charge detection and backflow preventing unit 9) before driving the motor 6 and starting the motion of the hands. Accordingly, the motor drive control unit 5 stops a charge from the solar cell 1 to the secondary cell 2. After having driven the motor 6, the motor drive control unit 5 brings the charge OFF signal to the “L” state and outputs the same to the charge-stop unit 30 (charge detection and backflow preventing unit 9). Accordingly, the motor drive control unit 5 gives permission to charge from the solar cell 1 to the secondary cell 2. In other words, the motor drive control unit 5 causes the charge-stop unit 30 to stop the charge to the secondary cell 2 before driving the motor 6, and gives the charge-stop unit 30 permission to charge after having driven the motor 6. In other words, the motor drive control unit 5 drives the motor 6 to bring the hands into motion in a state in which the charge from the solar cell 1 to the secondary cell 2 is stopped.

The motor drive control unit 5 detects the rotation of the motor 6, and determines whether or not the motion of the hands is normally performed. When the fact that the motion of the hands are not performed normally is detected, the motor drive control unit 5 drives the motor 6 again to cause the hands of the timepiece to indicate the accurate time of day.

The motor 6 brings the hand of the timepiece 200 into motion on the basis of a drive signal supplied from the motor drive control unit 5. In other words, the motor 6 is a time-of-day motor which measures time of day.

One of terminals of the switch 7 is connected to the motor drive control unit 5, and the other terminal thereof is connected to the power source line VDD. The switch 7 is a crown switch of the timepiece 200. When a crown is pulled out from the timepiece 200, the switch 7 is brought into, for example, a conducting state and, when the crown is pushed into the timepiece 200, the switch 7 is brought into, for example, a non-conducting state. When the crown is pulled out from the timepiece 200, the timepiece 200 stops the motion of the hands and assumes a state which allows setting of time of day. In other words, when the switch 7 is in the conducting state, the motor drive control unit 5 stops the driving of the motor 6.

The cell voltage detection unit 8 detects an output voltage (output potential difference) of the secondary cell 2 by being triggered by a detection sampling signal supplied from the low consumption mode control unit 10. When a state in which the output voltage of the secondary cell 2 is lower than a predetermined threshold value is detected, the cell voltage detection unit 8 outputs a low consumption mode detection signal to the low consumption mode control unit 10 as a detected result. More specifically, the low consumption mode detection signal becomes the “H” state when the output voltage of the secondary cell 2 is lower than the predetermined threshold value, and becomes the “L” state when the output voltage of the secondary cell 2 is the predetermined threshold value or higher.

The predetermined threshold value is a value larger than a minimum required voltage for driving the motor 6 by an amount corresponding to a predetermined voltage.

The charge detection and backflow preventing unit 9 (backflow preventing unit) in the charge-stop unit 30 detects a non-charged state indicating a state in which an output voltage (output potential difference) of the solar cell 1 is equal to or lower than the output voltage of the secondary cell 2 (output potential difference). When a non-charge state is detected, the charge detection and backflow preventing unit 9 outputs a charge detection signal to the low consumption mode control unit 10 as a detection result. More specifically, the charge detection signal becomes the “H” state when in the non-charge state. The charge detection signal becomes the “L” state when it is in a charge state indicating a state in which the output voltage of the solar cell 1 is larger than the output voltage of the secondary cell 2.

When in the non-charge state, the charge detection and backflow preventing unit 9 blocks (brings into the non-conducting state) the conduction between the power source line SVSS connected to the cathode terminal of the solar cell 1 and the power source line VSS connected to the cathode terminal of the secondary cell 2 by a switch 92. Accordingly, the charge detection and backflow preventing unit 9 prevents backflow of an electric current from the secondary cell 2 to the solar cell 1. In other words, when the output voltage of the solar cell 1 is equal to or lower than the output voltage of the secondary cell 2, the charge detection and backflow preventing unit 9 stops the charge to the secondary cell 2. Also, when stopping the charge to the secondary cell 2, the charge detection and backflow preventing unit 9 brings the connection between the anode terminal of the secondary cell 2 and the anode terminal of the solar cell 1 into the non-conducting state.

The charge detection and backflow preventing unit 9 inputs the charge OFF signal supplied from the motor drive control unit 5. The charge OFF signal is a signal supplied from the motor drive control unit 5 for a predetermined period before an output of the motor drive pulse, and is a signal which becomes the “H” state, for example. When the signal in the “H” state of the charge OFF signal is supplied to the charge detection and backflow preventing unit 9, the charge detection and backflow preventing unit 9 blocks the conduction between the power source line SVSS and the power source line VSS connected to the cathode terminal of the secondary cell 2. Detailed configuration of the charge detection and backflow preventing unit 9 will be described later.

By the operation of the charge-stop unit 30, the charge from the solar cell 1 to the secondary cell 2 is stopped before the rotation of the motor 6 (motion of the hands).

The charge detection and backflow preventing unit 9 includes a comparator 91, the switch 92, and an OR circuit 93 having two inputs. The switch 92 is made up of, for example, a semiconductor device such as an MOS transistor (metal oxide semiconductor field-effect transistor) or an analogue switch.

One of the input terminals of the comparator 91 is connected to the power source line SVSS connected to the cathode terminal of the solar cell 1, and the other input terminal thereof is connected to the power source line VSS connected to the cathode terminal of the secondary cell 2 respectively. An output from the comparator 91 is a charge detection signal.

When the output voltage of the solar cell 1 is equal to or lower than the output voltage of the secondary cell 2 (when in the non-charge state), the comparator 91 outputs the “H” state to the low consumption mode control unit 10 as the charge detection signal. Also, when the output voltage of the solar cell 1 is higher than the output voltage of the secondary cell 2, the comparator 91 outputs the “L” state to the low consumption mode control unit 10 as the charge detection signal.

One of the input terminal of the OR circuit 93 is connected to the output terminal of the comparator 91 and the other input terminal thereof is connected to a signal line of the charge OFF signal supplied from the motor drive control unit 5, respectively. The charge OFF signal is normally a signal in the “L” state, and is a signal becoming the “H” state when opening (in non-conducting state) the switch 92. ON/OFF (connect/open) of the switch 92 is controlled by a signal supplied from the output terminal of the OR circuit 93. For example, when the signal supplied from the OR circuit 93 is in the “H” state, the switch 92 is turned OFF (opened), and the connection between the power source line VSS and the power source line SVSS. Also, when the signal supplied from the OR circuit 93 is in the “L” state, the switch 92 is turned ON (connected) to bring the connection between the power source line VSS and the power source line SVSS in conduction.

Cases where the output from the OR circuit 93 becomes the “H” state and the switch 92 is turned OFF are two cases shown below.

In a first case, when the charge detection signal becomes the “H” state, that is, when a voltage generated by the solar cell 1 is lower than a charge voltage of the secondary cell 2, the switch 92 is opened to avoid backflow of the electric current from the secondary cell 2 to the solar cell 1. When an overcharge protecting operation is performed in the overcharge protecting unit 20 (when a switch 22 in the overcharge protecting unit 20 is ON) as well, the switch 92 is opened. The reason is that if the output terminal of the solar cell 1 is short-circuited via the switch 22, it is equivalent to a case where the voltage generated by the solar cell 1 is lowered when viewed from the charge detection and backflow preventing unit 9, so that the switch 92 is opened by the operation of the comparator 91.

A second case is a case where the charge OFF signal becomes the “H” state. In other words, the switch 92 is opened by the charge OFF signal supplied from the motor drive control unit 5 to stop the charge from the solar cell 1 to the secondary cell 2.

In this manner, the charge-stop unit 30 (charge detection and backflow preventing unit 9) prevents backflow of the electric current from the secondary cell 2 to the solar cell 1 when the voltage generated by the solar cell 1 is lower than the charge voltage of the secondary cell 2 by opening the switch 92 (in non-conducting state). The charge-stop unit 30 (charge detection and backflow preventing unit 9) stops the charge from the solar cell 1 to the secondary cell 2 by being controlled by the motor drive control unit 5. In addition, when the overcharge protecting operation is performed in the overcharge protecting unit 20, the charge-stop unit 30 (charge detection and backflow preventing unit 9) can prevent the output terminal of the secondary cell 2 from being short-circuited via the switch 22. When the output from the comparator 91 is in the “L” state (charged state), and when the charge OFF signal is in the “L” state, the charge-stop unit 30 (charge detection and backflow preventing unit 9) brings the power source line VSS and the power source line SVSS into conduction by the switch 92. Accordingly, the timepiece 200 is brought into the charge state in which the secondary cell 2 is charged by the electromotive force of the solar cell 1.

The overcharge protecting unit 20 includes a power generation detection unit 21 and the switch 22. The overcharge protecting unit 20 detects the output voltage (generated voltage) of the solar cell 1. When the detected voltage generated by the solar cell 1 becomes a predetermined threshold value or higher (when the generated voltage becomes excessive), the overcharge protecting unit 20 turns the switch 220N to short-circuit the power generating side to avoid overcharge of the secondary cell 2. Detailed configuration of the overcharge protecting unit 20 will be described later.

The power generation detection unit 21 detects whether or not the output potential difference of the solar cell 1 is equal to or higher than the predetermined threshold value. In other words, the power generation detection unit 21 determines whether or not the voltage generated by the solar cell 1 is excessive. The power generation detection unit 21 outputs the “H” state when voltage generated by the solar cell 1 is equal to or higher than the threshold value described above, and outputs the “L” state when it is lower than the threshold value described above.

The switch 22 is made up of, for example, the semiconductor element such as the MOS transistor or the analogue switch. One of the terminals of the switch 22 is connected to the anode element of the solar cell 1 and the other terminal thereof is connected to the cathode terminal of the solar cell 1. The switch 22 is controlled between ON/OFF (conduction/open) by the signal supplied from the power generation detection unit 21. For example, when the signal supplied from the power generation detection unit 21 is in the “H” state, that is, when the power generation detection unit 21 detects the fact that the voltage generated by the solar cell 1 is excessive, the switch 22 is turned ON (in conducting state), and the connection between the anode terminal and the cathode terminal of the solar cell 1 is short-circuited. Accordingly, when the voltage generated by the solar cell 1 is excessive, the output current of the solar cell 1 is bypassed to the switch 22 to stop the charge from the solar cell 1 to the secondary cell 2.

In this manner, when the voltage generated by the solar cell 1 becomes the predetermined voltage value or higher, the overcharge protecting unit 20 turns the switch 220N to short-circuit an output side of the solar cell 1, thereby preventing overcharge of the secondary cell 2 by causing an electric current supplied from the solar cell 1 to bypass. During the overcharge protection operation in which the output terminal of the solar cell 1 is short-circuited by the switch 22, the charge detection and backflow preventing unit 9 regards that the voltage generated by the solar cell 1 is lowered, and opens the switch 92 (in non-conducting state).

The low consumption mode control unit 10 determines whether or not the output voltage of the secondary cell 2 is equal to or lower than the predetermined threshold value described above on the basis of the detection result (low consumption mode detection signal) from the cell voltage detection unit 8. The low consumption mode control unit 10 also determines whether or not the output voltage of the solar cell 1 is in the non-charge state indicating a state of being equal to or lower than the output voltage of the secondary cell 2 on the basis of the detection result (charge detection signal) from the charge detection and backflow preventing unit 9. The low consumption mode control unit 10 translates the mode to the low-consumption mode on the basis of the low consumption mode detection signal and the charge detection signal.

The term “low consumption mode” here means a state in which the motor drive control unit 5 stops the driving of the motor 6 and the oscillation control unit 3 stops the output of the basic clock signal. Therefore, the low consumption mode control unit 10 causes the motor drive control unit 5 to stop the operation of the timepiece (motion of the hands operated by the motor 6) when translating the mode to the low consumption mode. The low consumption mode control unit 10 also causes the oscillation control unit 3 to stop the oscillation of the basic clock signal when translating the mode to the low consumption mode.

The low consumption mode control unit 10 causes the mode from the low consumption mode to the normal operation mode in which the time measuring operation is performed when not being in the non-charge state on the basis of the charge detection signal. The term “normal operation mode” here means a state in which the oscillation control unit 3 outputs the basic clock signal and the motor drive control unit 5 drives the motor 6.

The low consumption mode control unit 10 supplies the detection sampling signal to the cell voltage detection unit 8 as a trigger signal for detecting the output voltage of the secondary cell 2. The low consumption mode control unit 10 supplies the constant voltage ON/OFF signal to the oscillation control unit 3, and supplies the low consumption mode signal to the motor drive control unit 5. The low consumption mode control unit 10 performs control to translate the mode from the normal operation mode to the low consumption mode or from the low consumption mode to the normal operation mode by the constant voltage ON/OFF signal and the low consumption mode signal.

Subsequently, the operation in the first embodiment will be described.

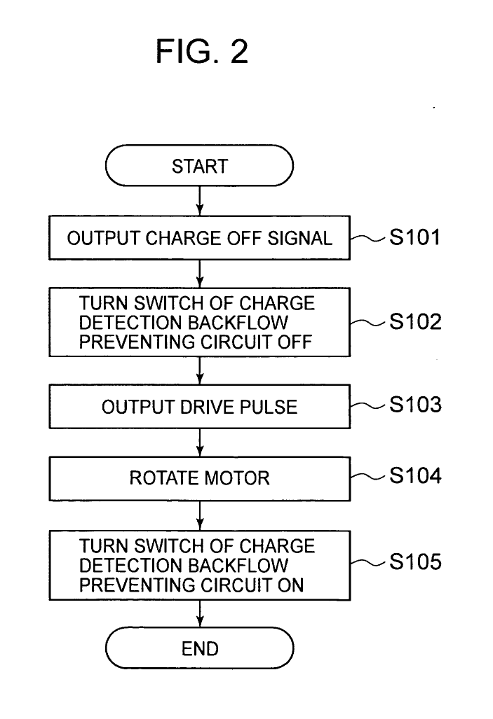

FIG. 2 is a flowchart showing an operation of the timepiece 200 according to the first embodiment. Referring now to the flowchart in FIG. 2, the operation of the timepiece 200 will be described.

A charge control process described here shows a flow of process to be performed when controlling the charge detection and backflow preventing unit 9 by the charge OFF signal supplied from the motor drive control unit 5.

The motor drive control unit 5 brings the charge OFF signal to the “H” state to output the same to the charge detection and backflow preventing unit 9 before driving the motor 6 and starting the motion of the hands (before the output of the motor drive pulse) (Step S101). The charge detection and backflow preventing unit 9 turns the switch 92 OFF by the charge OFF signal becoming the “H” state, and blocks the connection between the power source line VSS and the power source line SVSS (non-conducting state) (Step S102).

Subsequently, the motor drive control unit 5 outputs the drive pulse of the motor 6 (Step S103), and rotates the motor 6 to bring the hands of the timepiece 200 into motion (Step S104). In this case, detection of rotation of the motor 6 is also performed in order to determine whether or not the motion of the hands is performed normally. When the operation to cause the hands of the timepiece 200 into motion is completed, the motor drive control unit 5 changes the charge OFF signal to the “L” state and outputs a signal in the “L” state. The charge detection and backflow preventing unit 9 turns the switch 92 ON when the charge OFF signal becomes the “L” state, and brings the connection between the power source line VSS and the power source line SVSS into conduction (Step S105).

With the operation described thus far, in the drive control unit 100 and the timepiece 200, the motor drive control unit 5 causes the charge-stop unit 30 to stop the charge to the secondary cell 2 (secondary power source unit) by the electromotive force of the solar cell 1 (primary power source unit) before driving the motor 6. The motor drive control unit 5 also causes the charge-stop unit 30 to give permission to charge the secondary cell 2 by the electromotive force of the solar cell 1 after having driven the motor 6. In other words, the motor drive control unit 5 prevents the charge from flowing from the solar cell 1 to the secondary cell 2 by bringing the switch 92 of the charge detection and backflow preventing unit 9 into the non-conducting state before starting the driving of the motor 6. Accordingly, a power source voltage to supply the electric power during the driving of the motor 6 is prevented from changing even when the output voltage of the solar cell 1 varies. Therefore, the motor drive control unit 5 can rotate the motor 6 normally. The motor drive control unit 5 can prevent the occurrence of erroneous detection when detecting the fact that the motor 6 rotates normally, thereby preventing motion error which hinders accurate time measurement. Therefore, the drive control unit 100 and the timepiece 200 can drive the motor 6 normally even when the output voltage of the solar cell 1 varies.

The charge-stop unit 30 includes the charge detection and backflow preventing unit 9 (backflow preventing unit) configured to stop the charge to the secondary cell 2 when the output voltage of the solar cell 1 is equal to or lower than the output voltage of the secondary cell 2. Accordingly, the charge-stop unit 30 is capable of sharing the function with the charge detection and backflow preventing unit 9. Therefore, the motor 6 can be driven normally even when the output voltage of the solar cell 1 varies while restraining increase of the number of components of the drive control unit 100 and the timepiece 200.

### Second Embodiment

Referring now to the drawings, an electronic apparatus (for example, a timepiece apparatus) according to a second embodiment of the invention will be described.

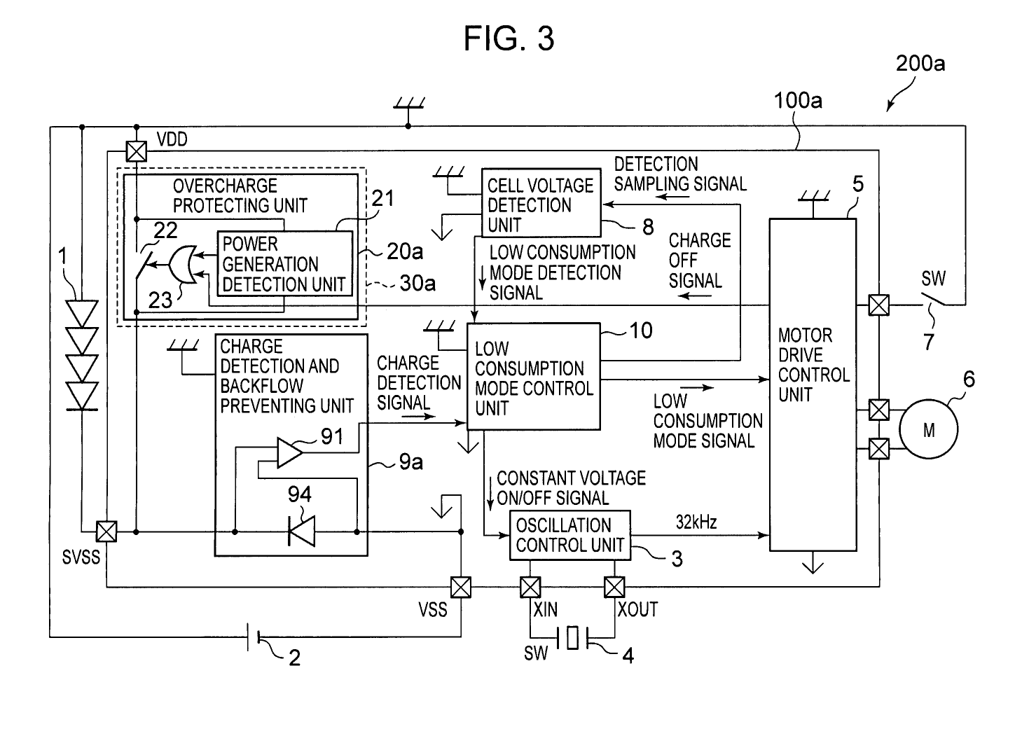

FIG. 3 is a schematic block diagram showing a timepiece 200a according to the second embodiment of the invention. In FIG. 3, the timepiece 200a includes the solar cell 1, the secondary check 2, the crystal oscillator 4, the motor 6 for time-of-day (for bringing hands into motion), the switch (SW) 7, and a drive control unit 100a. The drive control unit 100a includes the oscillation control unit 3, the motor drive control unit 5, the cell voltage detection unit 8, a charge detection blocking unit 9a, the low consumption mode control unit 10, and an overcharge protecting unit 20a. The timepiece 200a is the analogue-display-type electronic timepiece, for example, and the motor 6 for bringing hands into motion is the step motor.

In the timepiece 200a, the overcharge protecting unit 20a in the drive control unit 100a is included in a charge-stop unit 30a.

The timepiece 200a in the second embodiment is different from the timepiece 200 in the first embodiment shown in FIG. 1 in that the charge detection and backflow preventing unit 9 shown in FIG. 1 is replaced by the charge detection and backflow preventing unit 9a, and the overcharge protecting unit 20 shown in FIG. 1 is replaced by the overcharge protecting unit 20a shown in FIG. 3. Other configurations are the same as the timepiece 200 shown in FIG. 1. Therefore, the same components are designated by the same numbers as in the first embodiment and overlapped description will be omitted.

In the second embodiment, the motor drive control unit 5 brings the switch 22 of the overcharge protecting unit 20a into the conducting state when stopping the charge from the solar cell 1 to the secondary cell 2 before driving the motor 6. Accordingly, the motor drive control unit 5 short-circuits the output terminal of the solar cell 1, and causes the electric current supplied from the solar cell 1 to bypass to the switch 22. The charge of the secondary cell 2 is stopped.

In the charge detection and backflow preventing unit 9a, a diode 94 is used instead of the switch 92 in the charge detection and backflow preventing unit 9 in the first embodiment. The anode side of the diode 94 is connected to the power source line VSS and the cathode side thereof is connected to the power source line SVSS. In this configuration, when the voltage generated by the solar cell 1 is lower than the cell voltage of the secondary cell 2, the charge detection and backflow preventing unit 9a prevents backflow of the electric current from the secondary cell 2 to the solar cell 1. When the output terminal of the solar cell 1 is short-circuited by the switch 22, the charge detection and backflow preventing unit 9a avoids an output side of the secondary cell 2 by being short-circuited via the switch 22.

The charge stop unit 30a (overcharge protecting unit 20a) detects the output voltage (generated voltage) of the solar cell 1. When the detected voltage generated by the solar cell 1 becomes the predetermined threshold value or higher (when the generated voltage becomes excessive), the overcharge protecting unit 20a turns the switch 220N to short-circuit the power generating side to avoid overcharge of the secondary cell 2. When the output voltage of the solar cell 1 is equal to or higher than the predetermined threshold value, the overcharge protecting unit 20a stops the charge to the secondary cell 2. Also, when stopping the charge to the secondary cell 2, the overcharge protecting unit 20a brings the connection between the anode terminal of the solar cell 1 and the cathode terminal of the solar cell 1 into the conducting state.

The overcharge protecting unit 20a includes the power generation detection unit 21, the switch 22, and an OR circuit 23 having two inputs.

One of the input terminals of the OR circuit 23 is connected to the output terminal of the power generation detection unit 21 and the other input terminal thereof is connected to the signal line of the charge OFF signal supplied from the motor drive control unit 5, respectively. The charge OFF signal is normally the signal in the “L” state, and is a signal becoming the “H” state when bringing the switch 22 into the conducting state. ON/OFF (close/open) of the switch 22 is controlled by the signal supplied from an output terminal of the OR circuit 23. For example, when the signal supplied from the OR circuit 23 is in the “H” state, the switch 92 is turned ON (connected), and the connection between the anode terminal of the solar cell 1 and the cathode terminal of the solar cell 1 into the conducting state. Also, when the signal supplied from the OR circuit 23 is in the “L” state, the switch 92 is turned OFF (open), and the connection between the anode terminal of the solar cell 1 and the cathode terminal of the solar cell 1 into the non-conducting state.

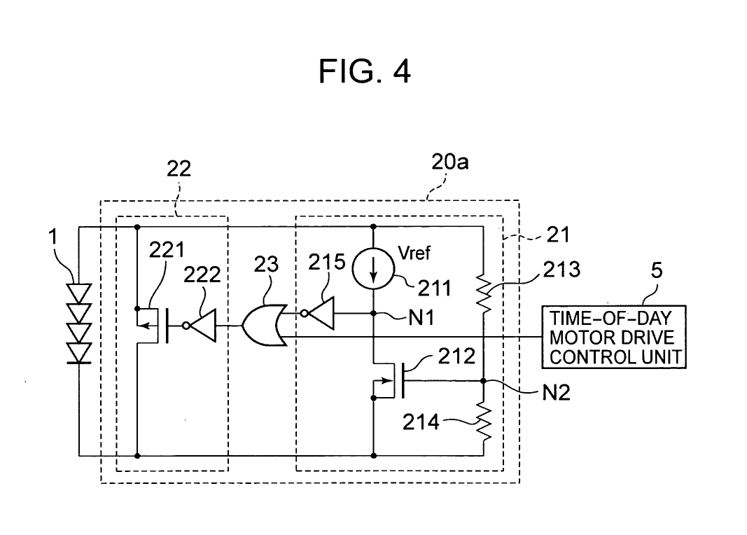

FIG. 4 is a schematic block diagram showing a configuration of the overcharge protecting unit 20a in the second embodiment.

In FIG. 4, the overcharge protecting unit 20a has a function to stop the charge from the solar cell 1 to the secondary cell 2 when the output voltage of the solar cell 1 becomes excessive as in the first embodiment, and furthermore, has a function to stop the charge from the solar cell 1 to the secondary cell 2 by the control from the motor drive control unit 5.

In the example in FIG. 4, the switch 22 includes a PMOS transistor (P-channel-type MOS transistor) 221 and an inverter 222.

A source terminal of the PMOS transistor 221 is connected to the anode element of the solar cell 1 and a drain terminal thereof is connected to the cathode terminal of the solar cell 1. A gate terminal of the PMOS transistor 221 is connected to an output terminal of the inverter 222.

An input terminal of the inverter 222 is connected to the output terminal of the OR circuit 23 so that the output from the OR circuit 23 is logically inverted.

The power generation detection unit 21 includes a reference voltage source (Vref) 211, an NMOS transistor (N-channel-type MOS transistor) 212, voltage dividing resistances 213 and 214, and an inverter 215. One of the terminals of the reference voltage source (Vref) 211 is connected to the anode terminal of the solar cell 1, and the other terminal thereof is connected via a node N1 to an input terminal of the inverter 215 and the drain terminal of the NMOS transistor 212. A source terminal of the NMOS transistor 212 is connected to the cathode terminal of the solar cell 1.

One ends of the resistance 213 is connected to the anode terminal of the solar cell 1, and the other end thereof is connected to one end of the resistance 214 via a node N2, and the other end of the resistance 214 is connected to the cathode terminal of the solar cell 1. Therefore, the node N2 is a resistive potential dividing point of the output voltage of the solar cell 1. A gate terminal of the NMOS transistor 212 is connected to the node N2. An output terminal of the inverter 215 is connected to one of the input terminals of the OR circuit 23, and the charge OFF signal supplied from the motor drive control unit 5 is supplied to the other input terminal of the OR circuit 23. The output terminal of the OR circuit 23 is connected to the input terminal of the inverter 222, and the output terminal of the inverter 222 is connected to the gate terminal of the PMOS transistor 221.

Subsequently, the operation in the second embodiment will be described.

First of all, the operation of the overcharge protecting unit 20a will be described.

In the overcharge protecting unit 20a, the voltage of the potential dividing point of the voltage dividing resistances 213 and 214 (the node N2) rises as the output voltage of the solar cell 1 rises. When the potential of the node N2 exceeds a predetermined threshold voltage value determined by the characteristics of the reference voltage source 211 and the NMOS transistor 212, the NMOS transistor 212 is turned ON. Then the NMOS transistor 212 is turned ON, the potential of a node N1 becomes the “L” state (the potential on the cathode side of the solar cell 1). Therefore, an input of the inverter 215 becomes the “L” state and an output of the same becomes the “H” state. An output of the inverter 222 connected to the inverter 215 becomes the “L” state, and the gate terminal of the PMOS transistor 221 becomes the “L” state. When the gate terminal of the PMOS transistor 221 becomes the “L” state, the PMOS transistor 221 is turned ON, and the anode terminal and the cathode terminal of the solar cell 1 are short-circuited.

In this manner, when the voltage generated by the solar cell 1 becomes the predetermined voltage value or higher, the PMOS transistor 221 is turned ON to short-circuit the output side of the solar cell 1, thereby preventing overcharge of the secondary cell 2 by causing the electric current supplied from the solar cell 1 to bypass through the PMOS transistor 221.

Also, as described above, the charge OFF signal is supplied from the motor drive control unit 5 to the other input terminal of the OR circuit 23. The charge OFF signal is the signal becoming the “H” state when stopping the charge of the secondary cell 2. By the charge OFF signal becoming the “H” state, the output terminal of the OR circuit 23 becomes the “H” state, and the output terminal of the inverter 222 becomes the “L” state, so that the PMOS transistor 221 is turned ON. When the PMOS transistor 221 is turned ON, the anode terminal and the cathode terminal of the solar cell 1 are short-circuited, and the electric current supplied from the solar cell 1 is bypassed through the PMOS transistor 221. Accordingly, the overcharge protecting unit 20a stops the charge from the solar cell 1 to the secondary cell 2.

In this manner, the overcharge protecting unit 20a according to the second embodiment is configured to receive a supply of the charge OFF signal from the motor drive control unit 5, and the motor drive control unit 5 stops the charge from the solar cell 1 to the secondary cell 2 by changing the charge OFF signal to the “H” state before driving the motor 6.

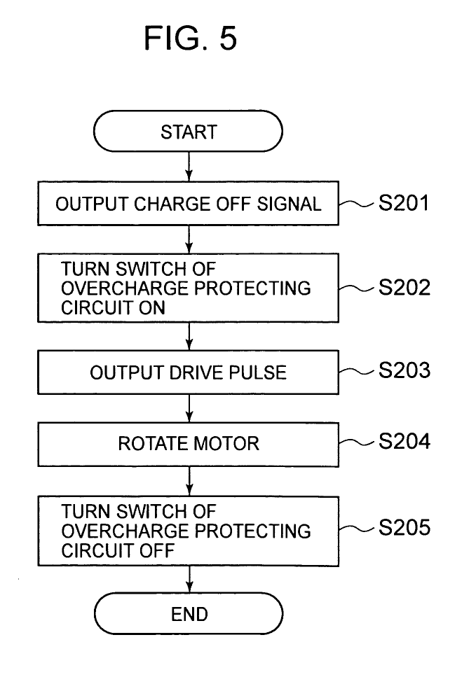

FIG. 5 is a flowchart showing an operation of the timepiece 200a according to the second embodiment. Referring now to the flowchart in FIG. 5, the operation of the timepiece 200a will be described.

A charge control process described here shows a flow of process to be performed when controlling the overcharge protecting unit 20a by the charge OFF signal supplied from the motor drive control unit 5.

The motor drive control unit 5 brings the charge OFF signal to the “H” state to output the same to the overcharge protecting unit 20a before driving the motor 6 and starting the motion of the hands (before the output of the motor drive pulse) (Step S201). When the charge OFF signal becomes the “H” state, the overcharge protecting unit 20a turns the switch 22 (more specifically, the PMOS transistor 221) ON (conducting state), and connects the anode terminal and the cathode terminal of the solar cell 1 by the switch 22 (Step S202). Accordingly, the switch 22 of the overcharge protecting unit 20a is turned ON to short-circuit the power generating side, and causes the output current of the solar cell 1 to bypass by the switch 22, so that the charge from the solar cell 1 to the secondary cell 2 is stopped. When the switch 22 of the overcharge protecting unit 20a is turned ON (conducting state), the output voltage of the solar cell 1 is lowered to a level below the output voltage of the secondary cell 2. Therefore, the diode 94 of the charge detection and backflow preventing unit 9a is brought into the non-conducting state.

Subsequently, the motor drive control unit 5 outputs the drive pulse of the motor 6 (Step S203), and rotates the motor 6 to bring the hands of the timepiece 200a into motion (Step S204). In this case, detection of rotation of the motor 6 is also performed in order to determine whether or not the motion of the hands is performed normally.

When the operation to cause the hands of the timepiece 200a into motion is completed, the motor drive control unit 5 changes the charge OFF signal to the “L” state and outputs the signal in the “L” state after a certain period has elapsed. When the charge OFF signal becomes the “L” state, the overcharge protecting unit 20a turns the switch 22 OFF (non-conducting state) (Step S205). Accordingly, the charge from the solar cell 1 to the secondary cell 2 is restarted.

With the operation described thus far, in the drive control unit 100a and the timepiece 200a, the motor drive control unit 5 causes the charge-stop unit 30a to stop the charge to the secondary cell 2 (secondary power source unit) by the electromotive force of the solar cell 1 (primary power source unit) before driving the motor 6. The motor drive control unit 5 also causes the charge-stop unit 30a to give permission to charge the secondary cell 2 by the electromotive force of the solar cell 1 after having driven the motor 6. In other words, the motor drive control unit 5 prevents the charge from flowing from the solar cell 1 to the secondary cell 2 by causing the charge current flowing from the solar cell 1 to bypass by the switch 22 of the overcharge protecting unit 20a before starting the driving of the motor 6. Accordingly, the power source voltage to supply an electric power during the driving of the motor 6 is prevented from changing even when the output voltage of the solar cell 1 varies. Therefore, the motor drive control unit 5 can rotate the motor 6 normally. The motor drive control unit 5 can prevent the occurrence of erroneous detection when detecting the fact that the motor 6 rotates normally, thereby preventing motion error which hinders the accurate time measurement. Therefore, the drive control unit 100a and the timepiece 200a can drive the motor 6 normally even when the output voltage of the solar cell 1 varies in the same manner as in the first embodiment.

The charge-stop unit 30a includes the overcharge protecting unit 20a which stops the charge to the secondary cell 2 when the output voltage of the solar cell 1 is equal to or lower than the output voltage of the secondary cell 2. Accordingly, the charge-stop unit 30a can share the function with the overcharge protecting unit 20a. Therefore, the motor 6 can be driven normally even when the output voltage of the solar cell 1 varies while restraining increase of the number of components of the drive control unit 100a and the timepiece 200a.

Regarding the charge detection and backflow preventing unit 9a in the second embodiment, an example in which the diode 94 is inserted between the power source line SVSS and the power source line VSS to prevent the backflow of the electric current from the secondary cell 2 to the solar cell 1 is shown. However, the invention is not limited thereto, and the charge detection and backflow preventing unit 9 having the switch 92 may be used as in the first embodiment.

According to the second embodiment of the invention, the drive control unit 100 (or 100a) includes the motor drive control unit 5 configured to stop the charge of the secondary cell 2 (secondary power source unit) by the electromotive force of the solar cell 1 (primary power source unit) before driving the motor 6, and give permission to restart the charge after having driven the motor 6.

Accordingly, the drive control unit 100 (or 100a) can drive the motor 6 normally even when the output voltage of the solar cell 1 (primary power source unit) varies.

The drive control unit 100 (or 100a) includes the charge-stop unit 30 (or 30a) configured to stop the charge to the secondary cell 2, and the motor drive control unit 5 causes the charge-stop unit 30 (or 30a) to stop the charge from the solar cell 1 to the secondary cell 2 before driving the motor 6 and give permission to restart the charge after having driven the motor 6.

In the drive control unit 100 (or 100a) configured in this manner, the charge-stop unit 30 (or 30a) is activated before driving the motor 6 to stop the charge from the solar cell 1 to the secondary cell 2. Then, after having driven the motor 6, the charge from the solar cell 1 to the secondary cell 2 is restarted.

Accordingly, the drive control unit 100 (or 100a) can drive the motor 6 normally even when the output voltage of the solar cell 1 varies.

The charge-stop unit 30a includes the overcharge protecting unit 20a which stops the charge to the secondary cell 2 when the output voltage (output potential difference) of the solar cell 1 is equal to or higher than the predetermined threshold value.

In the drive control unit 100a configured in this manner, when the output voltage (output potential difference) of the solar cell 1 is equal to or higher than the predetermined threshold value, the charge to the secondary cell 2 is stopped in order to avoid the overcharge of the secondary cell 2.

Accordingly, the charge stop unit 30a is capable of preventing deterioration of the secondary cell 2 caused by the overcharge of the secondary cell 2. In addition, the charge stop unit 30a can share the function to protect the secondary cell 2 from being overcharged. Therefore, the motor 6 can be driven normally even when the output voltage of the solar cell 1 varies while restraining increase of the number of components of the drive control unit 100a.

The charge-stop unit 30 includes the charge detection and backflow preventing unit 9 (backflow preventing unit) configured to stop the charge to the secondary cell 2 when the output voltage of the solar cell 1 (output potential difference) is equal to or lower than the output voltage (output potential difference) of the secondary cell 2.

In the drive control unit 100 configured in this manner, when the output voltage of the solar cell 1 is equal to or lower than the output voltage of the secondary cell 2, the charge to the secondary cell 2 is stopped.

Accordingly, the charge-stop unit 30 can avoid the backflow of the electric current from the secondary cell 2 to the solar cell 1. In addition, the charge-stop unit 30 can also share the function to prevent the backflow of the electric current from the secondary cell 2 to the solar cell 1. Therefore, the motor 6 can be driven normally even when the output voltage of the solar cell 1 varies while restraining increase of the number of components of the drive control unit 100.

Also, when stopping the charge to the secondary cell 2, the charge-stop unit 30 (or 30a) brings the connection between the anode terminal of the secondary cell 2 and the anode terminal of the solar cell 1 or the connection between the cathode terminal of the secondary cell 2 and the cathode terminal of the solar cell 1 into the non-conducting state.

When stopping the charge to the secondary cell 2, the drive control unit 100 (or 100a) as described above, for example, opens the connection between the anode terminal of the secondary cell 2 and the anode terminal of the solar cell 1 by the switch 92 and brings into the non-conducting state.

Accordingly, the drive control unit 100 (or 100a) brings the connection between the secondary cell 2 and the solar cell 1 into the non-conducting state to stop the charge of the secondary cell 2.

The drive control unit 100a also includes the charge detection and backflow preventing unit 9a configured to bring the connection between the anode terminal of the secondary cell 2 and the anode terminal of the solar cell 1 or the connection between the cathode terminal of the secondary cell 2 and the cathode terminal of the solar cell 1 into the non-conducting state when the output voltage of the solar cell 1 (output potential difference) is equal to or lower than the output voltage (output potential difference) of the secondary cell 2, and the charge stop unit 30a includes the overcharge protecting unit 20a configured to bring the connection between the anode terminal of the solar cell 1 and the cathode terminal of the solar cell 1 into the conducting state when stopping the charge to the secondary cell 2.

In the drive control unit 100a configured in this manner, the charge detection and backflow preventing unit 9a brings, for example, the connection between the anode terminal of the secondary cell 2 and the anode terminal of the solar cell 1 into the non-conducting state to prevent the backflow of the electric current from the secondary cell 2 to the solar cell 1 when the output voltage (output potential difference) of the solar cell 1 is equal to or lower than the output voltage (the output potential difference) of the secondary cell 2. When stopping the charge of the secondary cell 2, the anode terminal and the cathode terminal of the solar cell 1 are connected by the switch 22 to cause the output current of the solar cell 1 to bypass. Therefore, the output voltage of the solar cell 1 is lowered, and the charge detection and backflow preventing unit 9a is activated, so that the charge of the secondary cell 2 is stopped.

Accordingly, the drive control unit 100a can stop the charge of the secondary cell 2 by causing the output current of the solar cell 1 to bypass.

In the embodiments described above, the primary power source unit is the solar cell 1.

Accordingly, since the solar cell 1 can convert the light energy directly to the electric power, the number of components of the primary power source unit can be reduced.

Also, in the embodiments described above, the motor 6 is a time-of-day motor which measures time of day.

Accordingly, even when the output voltage of the solar cell 1 varies, the time of day can be measured accurately.

### Third Embodiment

Referring now to the drawings, an electronic apparatus (for example, a timepiece apparatus) according to a third embodiment of the invention will be described. In the timepiece according to the third embodiment, the charge of the secondary cell is attenuated in a main drive pulse generating period in which a main drive pulse to be supplied to the motor for bringing a secondhand into motion and a rotation detection period for detecting the rotation of the motor for restraining variations of the voltage of the secondary cell.

In the main drive pulse generating period and the rotation detection period, the timepiece is subjected to the variations of the voltage of the secondary cell in comparison with other periods. In the timepiece according to the third embodiment, the charge of the secondary cell is attenuated in these periods. The timepiece according to the third embodiment is configured not to attenuate the charge during periods other than the above-described periods. Accordingly, in the timepiece according to the third embodiment, the possible amount of charge of the secondary cell is larger than those in the first and second embodiments.

In the timepiece according to the third embodiment, the periods to attenuate the charge of the secondary cell (charge attenuating periods) are not limited to the periods described above, and the charge attenuating periods may need only to include at least the main drive pulse generating period.

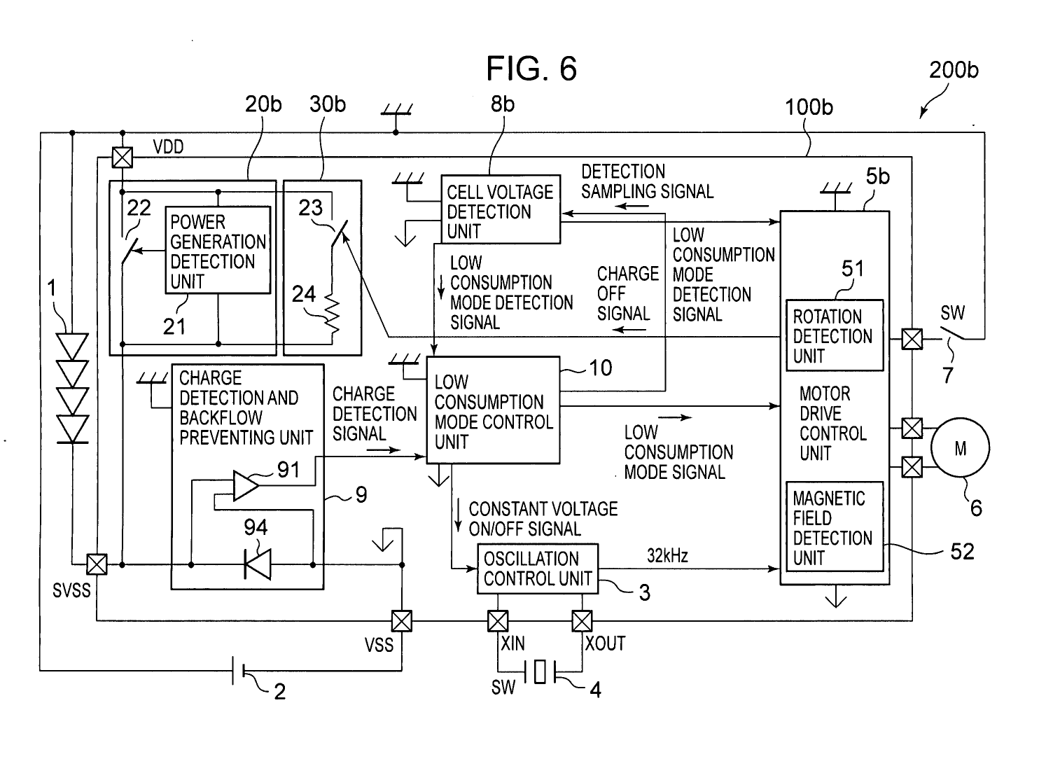

FIG. 6 is a schematic block diagram showing a timepiece 200b according to the third embodiment of the invention.

In FIG. 6, the timepiece 200b includes the solar cell 1, the secondary check 2, the crystal oscillator 4, the motor 6 for time-of-day (for bringing the hands into motion), the switch (SW) 7, and a drive control unit 100b. The drive control unit 100b includes the oscillation control unit 3, a motor drive control unit 5b, a cell voltage detection unit 8b, the charge detection and backflow preventing unit 9, the low consumption mode control unit 10, an overcharge protecting unit 20b, and a charge stop unit 30b. The timepiece 200b is the analogue-display-type electronic timepiece, for example, and the motor 6 for bringing hands into motion is the step motor.

The timepiece 200b is different from the timepiece 200a in the second embodiment shown in FIG. 3 in that the motor drive control unit 5 shown in FIG. 3 is replaced by the motor drive control unit 5b shown in FIG. 6, the cell voltage detection unit 8 shown in FIG. 3 is replaced by the cell voltage detection unit 8b shown in FIG. 6, the overcharge protecting unit 20a shown in FIG. 3 is replaced by the overcharge protecting unit 20b shown in FIG. 6, and the charge stop unit 30a shown in FIG. 3 is replaced by the charge stop unit 30b shown in FIG. 6. Other configurations are the same as the timepiece 200a shown in FIG. 3. Therefore, the same components are designated by the same numbers and overlapped description will be omitted. Since the configuration of the overcharge protecting unit 20b is the same as the overcharge protecting unit 20 in the first embodiment, the repeated description is avoided.

The cell voltage detection unit 8b detects the output voltage (output potential difference) of the secondary cell 2 by being triggered by the detection sampling signal supplied from the low consumption mode control unit 10 in the same manner as the cell voltage detection unit 8 in the first and second embodiments. When the detected output voltage of the secondary cell 2 is lower than a predetermined threshold value, the cell voltage detection unit 8b brings the low consumption mode detection signal to the “H” state. In contrast, when the detected output voltage of the secondary cell 2 is equal to or higher than the predetermined threshold value, the cell voltage detection unit 8b brings the low consumption mode detection signal to the “L” state. Then, the cell voltage detection unit 8b outputs the low consumption mode detection signal to the low consumption mode control unit 10 and the motor drive control unit 5b. The predetermined threshold value is a value larger than a minimum required voltage for driving the motor 6 by an amount corresponding to a predetermined voltage.

The charge stop unit 30b changes the intensity of the charge from the solar cell 1 to the secondary cell 2 on the basis of a charge OFF signal supplied from the motor drive control unit 5b. More specifically, for example, the charge stop unit 30b attenuates the charge when the charge OFF signal is in the “H” state. In contrast, the charge stop unit 30b intensifies the charge when the charge OFF signal is in the “L” state. Here, the attenuation of the charge means to reduce the charge from the current state, and if the charge is currently in progress, it includes the stop of the charge. The intensification of the charge means to increase the charge from the current state, and if the charge is not currently in progress, it includes the start of the charge.

The charge stop unit 30b includes a switch 23 and a resistance 24.

The switch 23 is made up of, for example, the semiconductor element such as the MOS transistor or the analogue switch. One of the terminals of the switch 23 is connected to the anode element of the solar cell 1 and the other terminal thereof is connected to the resistance 24. The switch 23 turns ON/OFF (conduction/open) by the charge OFF signal supplied from the motor drive control unit 5b.

For example, when the charge OFF signal supplied from the motor drive control unit 5b is in the “H” state, that is, when the power generation detection unit 21 detects the fact that the voltage generated by the solar cell 1 is equal to or higher than the predetermined threshold value, the switch 23 is turned ON (conducting state). Accordingly, the resistance 24 is inserted between the anode terminal and the cathode terminal of the solar cell 1 and the electric current supplied from the solar cell 1 is bypassed to the resistance 24, so that the electric current supplied from the solar cell 1 to the secondary cell 2 is reduced, and the charge from the solar cell 1 to the secondary cell 2 is attenuated.

In contrast, when the charge OFF signal supplied from the motor drive control unit 5b is in the “L” state, that is, when the power generation detection unit 21 detects the fact that the voltage generated by the solar cell 1 is lower than the predetermined threshold value, the switch 23 is turned OFF (open state), and the connection between the anode terminal and the cathode terminal of the solar cell 1 is opened. Accordingly, the resistance 24 between the anode terminal and the cathode terminal of the solar cell 1 is disconnected and the electric current bypassed to the resistance 24 is supplied to the secondary cell 2, so that the electric current supplied from the solar cell 1 to the secondary cell 2 is increased, and the charge from the solar cell 1 to the secondary cell 2 is intensified.

The motor drive control unit 5b has the same function as the motor drive control unit 5 in the second embodiment, but is different in the following points. The motor drive control unit 5b attenuates the charge of the secondary cell 2 by the electromotive force of the solar cell 1 to a level lower than the charge at that moment before driving a motor, and then intensifies the charge to a level higher than the charge at that moment after having driven the above-described motor. In other words, the motor drive control unit 5b attenuates the charge while the motor is driven in comparison with the period where the motor is not driven. Here, the charge in the period when the motor is not driven means an average charge before driving the motor and after the driving of the motor.

More specifically, for example, when the motor drive control unit 5b attenuates the charge from the solar cell 1 to the secondary cell 2 before driving the motor 6, the switch 23 of the charge stop unit 30b is brought into the conducting state and the resistance 24 is inserted between the anode terminal and the cathode terminal of the solar cell 1. Accordingly, since the electric current supplied from the solar cell 1 is bypassed to the resistance 24, the electric current supplied from the solar cell 1 to the secondary cell 2 is reduced, so that the charge from the solar cell 1 to the secondary cell 2 is attenuated.

The motor drive control unit 5b includes a rotation detection unit 51 and a magnetic field detection unit 52. The rotation detection unit 51 detects a voltage VRS generated by being chopped by a sampling pulse SPK (hereinafter, referred to as the detected voltage VRS). When an absolute value of the detected voltage VRS is equal to or higher than a predetermined threshold value VCOMP, the rotation detection unit 51 determines that the motor is rotating. In contrast, when any one of the absolute values of one or more detected voltages VRS detected during a predetermined rotation detection period do not reach or exceeds the predetermined threshold value VCOMP, the rotation detection unit 51 determines that the motor is not rotating.

When the rotation detection unit 51 of the motor drive control unit 5b determines that the motor is rotating, since the motor 6 is already rotating, there arises no problem even though the voltage of the secondary cell 2 varies. Therefore, the motor drive control unit 5b controls to intensify the charge of the secondary cell 2 for charging the secondary cell 2 even for a short time.

More specifically, for example, the motor drive control unit 5b brings the charge OFF signal into the “L” state so as to intensify the charge of the secondary cell 2, and outputs the charge OFF signal to the switch 23. Accordingly, the motor drive control unit 5b brings the switch 23 to the open state, and causes the electric current supplied from the solar cell 1 to be supplied directly to the secondary cell 2, so that the charge from the solar cell 1 to the secondary cell 2 can be intensified.

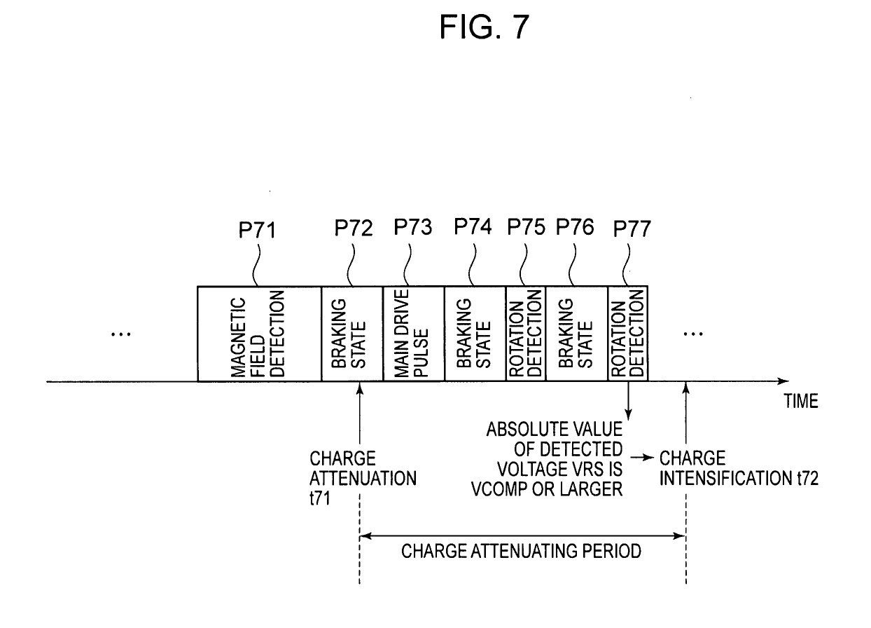

Referring now to FIG. 7, the process of the above described motor drive control unit 5b will be described. FIG. 7 is an explanatory drawing showing an example of a process of intensifying the charge when the motor drive control unit 5b determines that the motor is rotating. In FIG. 7, the lateral axis represents time and the normal direction of the lateral axis corresponds to the direction of elapse of time. Periods of the respective processes of the motor drive control unit 5b are shown in sequence of the elapse of time. More specifically, respective periods of a magnetic field detection P71 which indicates the detection of a magnetic field, a braking state P72 which indicates a braking state, a main drive pulse P73 which is supplied to the motor 6, a braking state P74, a rotation detection P75 which detects the rotation of the motor, a braking state P76 and a rotation detection P77 are shown in the sequence of elapse of time.

In the example shown in FIG. 7, the motor drive control unit 5b controls to attenuate the charge during the period in the braking state P72. When the detected voltage VRS is equal to or lower than the VCOMP during the period of the rotation detection P77, the motor drive control unit 5b determines that the motor is rotating and controls the charge of be intensified. In this case, the charge attenuating period in which the charge is attenuated is a period from a time of charge attenuation t71 to a time of charge intensification t72 shown in FIG. 7. In other words, the charge attenuating period includes the main drive pulse generating period of the motor and a period from the start of the detection of rotation of the motor by the rotation detection unit until the rotation is detected.

In the third embodiment, the charge attenuating period is defined to be the period including the main drive pulse generating period of the motor and the period from the start of detection of rotation of the motor by the rotation detection unit until the rotation is detected. However, the invention is not limited thereto, and at least the charge attenuating period may need only be the main drive pulse generating period of the motor.

Returning back to FIG. 6, when the rotation detection unit 51 determines that the motor is not rotating, the motor drive control unit 5b supplies a correction drive pulse having larger energy than the main drive pulse to the motor 6, and hence the motor 6 can bring the hands into motion reliably even when the voltage of the secondary cell 2 varies. Here, the correction drive pulse is, for example, a pulse having sufficient energy for rotating the motor reliably, and is a predetermined pulse. Accordingly, the motor drive control unit 5b controls to intensify the charge of the secondary cell 2 for charging the secondary cell 2 even for a short time.

More specifically, for example, the motor drive control unit 5b brings the charge OFF signal into the “L” state to intensify the charge of the secondary cell 2, and output the charge OFF signal to the switch 23. Accordingly, the motor drive control unit 5b brings the switch 23 to the open state to release the resistance 24 between the anode terminal and the cathode terminal of the solar cell 1, and increases the electric current from the solar cell 1 to the secondary cell 2, so that the charge from the solar cell 1 to the secondary cell 2 is intensified.

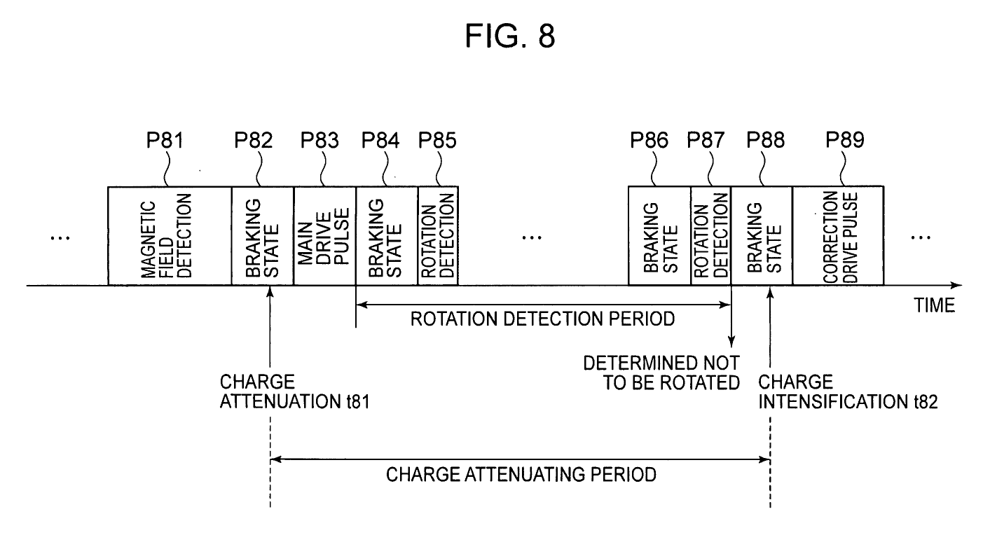

Referring now to FIG. 8, the process of the above-described motor drive control unit 5b will be described. FIG. 8 is an explanatory drawing showing an example of a process of intensifying the charge when the motor drive control unit 5b determines that the motor is not rotating. In FIG. 8, the lateral axis represents time and the normal direction of the lateral axis corresponds to the direction of elapse of time. Periods of the respective processes of the motor drive control unit 5b are shown in sequence of the elapse of time. More specifically, respective periods of a magnetic field detection P81, an braking state P82, a main drive pulse P83, a braking state P84, a rotation detection P85, a braking state P86, a rotation detection P87, a braking state P88, and a correction drive pulse P89 in which the correction drive pulse is supplied to the motor 6 are shown in sequence of elapse of the time.

In the example shown in FIG. 8, the motor drive control unit 5b controls to attenuate the charge during the period in the braking state P82. If none of the absolute value of the detected voltage VRS becomes the predetermined threshold value VCOMP or higher during the rotation detection periods from the braking state P84 to the rotation detection P87, the motor drive control unit 5b determines that the motor is not rotating when the absolute value of the detected voltage VRS during the period of the rotation detection P87 is determined to be lower than the predetermined threshold value VCOMP. Then, the motor drive control unit 5b controls to intensify the charge. In this case, the charge attenuating period in which the charge is attenuated is a period from a time of charge attenuation t81 to a time of charge intensification t82 shown in FIG. 8.

Returning back to FIG. 6, the magnetic field detection unit 52 detects a voltage VRSJ (hereinafter, referred to as detected voltage VRSJ) generated by being chopped by a sampling pulse SPJ. When an absolute value of the detected voltage VRSJ is equal to or higher than a predetermined threshold value VINV, the magnetic field detection unit 52 determines that the magnetic field is detected. Then, when it is determined that the magnetic field is detected by the magnetic field detection unit 52, the motor drive control unit 5b translates the mode to a fixed pulse mode.

When the mode is translated to the fixed pulse mode, for example, the motor drive control unit 5b does not supply the main drive pulse to the motor 6, and supplies a magnetic field detection fixed pulse to the motor 6 at timing when the main drive pulse is supplied. In other words, the intensification of the charge by the motor drive control unit 5b is performed when the detected magnetic field is higher than the predetermined magnetic field.

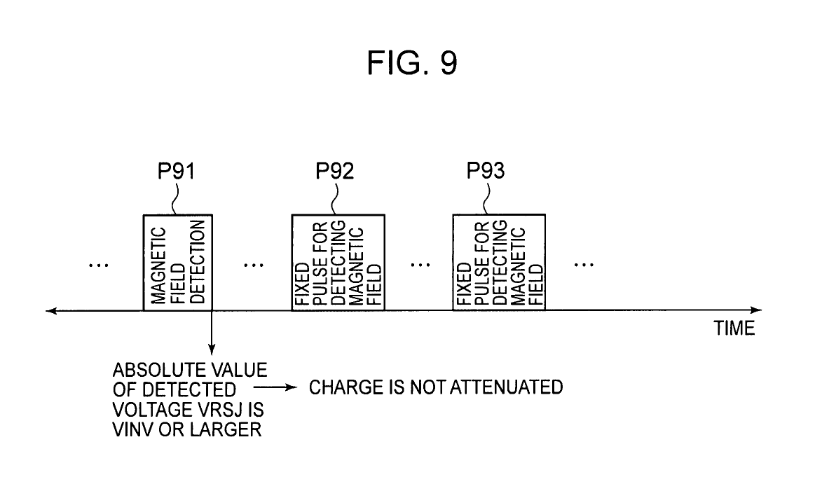

Referring now to FIG. 9, the process of the above-described motor drive control unit 5b will be described. FIG. 9 is an explanatory drawing showing an example of a process of intensifying the charge when the motor drive control unit 5b determines that the magnetic field is detected. In FIG. 9, the lateral axis represents time and the normal direction of the lateral axis corresponds to the direction of elapse of time. Periods of the respective processes of the motor drive control unit 5b are shown in sequence of the elapse of time. More specifically, respective periods of magnetic field detection P91, and respective periods of the fixed pulse P92 for detecting the magnetic field and the fixed pulse P93 for detecting the magnetic field are shown in sequence of the elapse of time.

In the example shown in FIG. 9, since the absolute value of the detection voltage VRSJ is equal to or higher than the predetermined threshold value VINV or higher during the period of the magnetic field detection P91, the motor drive control unit 5b determines that the magnetic field is detected. In this case, the motor drive control unit 5b does not attenuate the charge, and supplies the fixed pulse P92 for detecting the magnetic field and the fixed pulse P93 for detecting the magnetic field to the motor 6 instead of the main drive pulse at timing when the primary pulse is supplied.

Returning back to FIG. 6, the motor drive control unit 5b exercises control to intensify the charge of the secondary cell 2 on the basis of the low consumption mode detection signal supplied from the cell voltage detection unit 8. More specifically, for example, when the low consumption mode detection signal in the “H” state is supplied, that is, when the voltage of the secondary cell 2 is lower than the predetermined threshold value during the charge attenuating period, the motor drive control unit 5b translates the driving to the fixed pulse drive, and brings the charge OFF signal to the “L” state.

The motor drive control unit 5b supplies the fixed pulse to the motor 6 when the driving is translated to the fixed pulse drive. The motor drive control unit 5b outputs the charge OFF signal to the switch 23. Accordingly, the motor drive control unit 5b brings the switch 23 to the open state to release the resistance 24 between the anode terminal and the cathode terminal of the solar cell 1, so that the electric current from the solar cell 1 to the secondary cell 2 is increased, and the charge from the solar cell 1 to the secondary cell 2 is intensified. In summary, the intensification of the charge by the motor drive control unit 5b is performed when the detected voltage is equal to or lower than the predetermined voltage.

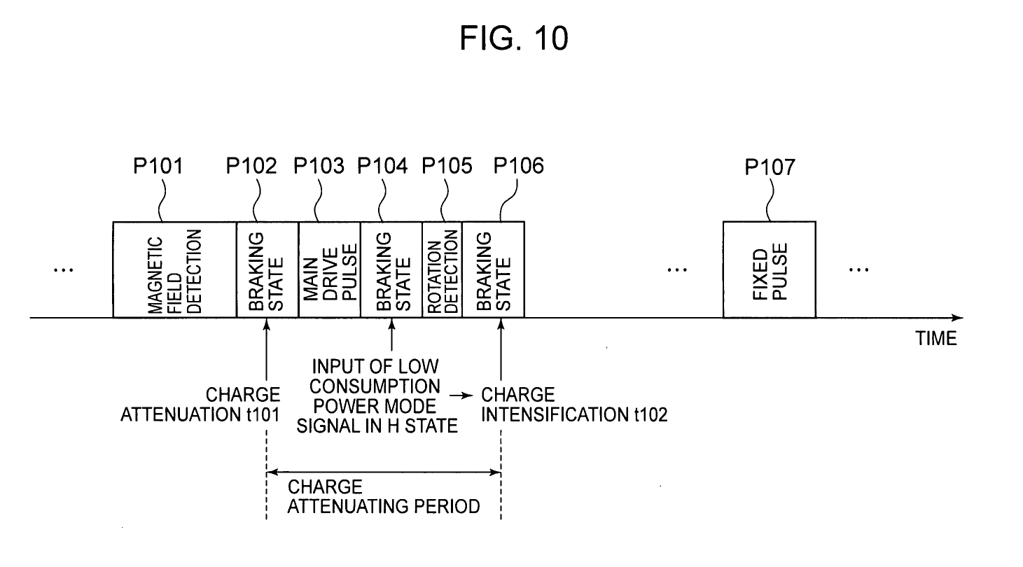

Referring now to FIG. 10, the process of the above-described motor drive control unit 5b will be described. FIG. 10 is an explanatory drawing showing an example of the process of intensifying the charge by the motor drive control unit 5b when the voltage of the secondary cell 2 is lowered. In FIG. 10, the lateral axis represents time and the normal direction of the lateral axis corresponds to the direction of elapse of time. Periods of the respective processes of the motor drive control unit 5b are shown in sequence of the elapse of time. More specifically, respective periods of a magnetic field detection P101, a braking state P102, a main drive pulse P103, a braking state P104, a rotation detection P105, a braking state P106, and a fixed pulse P107 in which the fixed pulse is supplied to the motor 6 are shown in sequence of elapse of the time.

In the example shown in FIG. 10, the motor drive control unit 5b controls so as to attenuate the charge during the period in the braking state P102. When the low consumption mode detection signal in the “H” state is supplied from the cell voltage detection unit 8, that is, when the voltage of the secondary cell 2 is lower than the predetermined threshold value during the period of the braking state P104, the motor drive control unit 5b translates the mode to the fixed pulse mode, and exercises control to intensify the charge of the secondary cell 2. In this case, the charge attenuating period in which the charge is attenuated is a period from a time of charge attenuation t101 to a time of charge intensification t102 shown in FIG. 10.

Returning back to FIG. 6, the motor drive control unit 5b may exercise the control to intensify the charge after having translated to a time of day correction notification motion or a demonstration motion by the fixed pulse drive (for example, the motion to move a long hand once in two seconds).

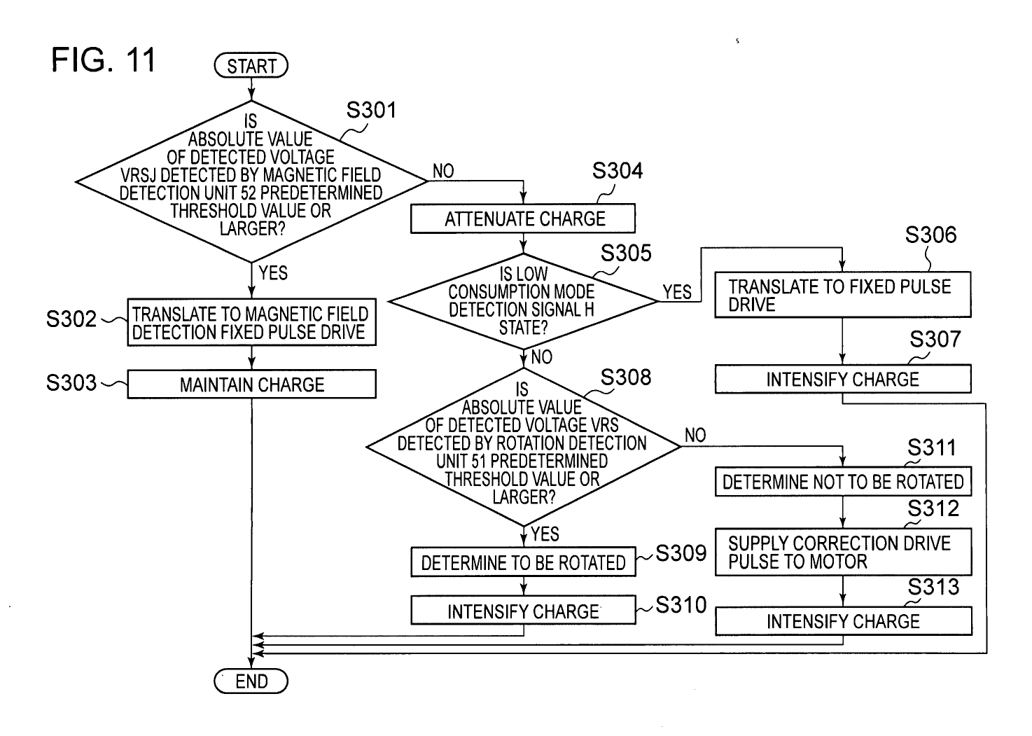

FIG. 11 is a flowchart showing an example of an operation of the motor drive control unit 5b in the third embodiment. First of all, the motor drive control unit 5b determines whether or not the absolute value of the detected voltage VRSJ detected by the magnetic field detection unit 52 is equal to or higher than the predetermined threshold value (Step S301). When the absolute value of the detected voltage VRSJ is equal to or larger than the predetermined threshold value (Yes, in Step S301), the motor drive control unit 5b translates the driving to the magnetic field detection fixed pulse drive (Step S302), and maintains the current charge of the secondary cell 2.

In contrast, when the absolute value of the detected voltage VRSJ is smaller than the predetermined threshold value (No, in Step S301), the motor drive control unit 5b attenuates the charge (Step S304). Subsequently, the motor drive control unit 5b determines whether or not the low consumption mode detection signal is in the “H” state (Step S305). When the low consumption mode detection signal is in the “H” state (Yes, in Step S305), the motor drive control unit 5b translates the drive the fixed pulse drive (Step S306), and exercises control to intensify the charge of the secondary cell 2 (Step S307).

In contrast, when the low consumption mode detection signal is in the “L” state (NO, in Step S305), the motor drive control unit 5b determines whether or not the absolute value of the detected voltage VRS detected by the rotation detection unit 51 is equal to or larger than the predetermined threshold value (Step S308). When the absolute value of the detected voltage VRS is equal to or larger than the predetermined threshold value (Yes, in Step S308), the motor drive control unit 5b determines that the motor is rotating (Step S309), and exercises control to intensify the charge of the secondary cell (Step S310).

In contrast, when the absolute value of the detected voltage VRS is smaller than the predetermined threshold value (No, in Step S308), the motor drive control unit 5b determines that the motor is not rotating (Step S311), supplies the correction drive pulse to the motor (Step S312), and controls to intensify the charge of the secondary cell 2 (Step S313). With the procedure described thus far, the process of this flowchart is ended.

With the operation described thus far, in the drive control apparatus 100b and the timepiece 200b, the motor drive control unit 5b causes the charge-stop unit 30b to attenuate the charge to the secondary cell 2 (secondary power source unit) by the electromotive force of the solar cell 1 (primary power source unit) before driving the motor 6. In other words, the motor drive control unit 5b inserts the resistance 24 between the anode terminal and the cathode terminal of the solar cell 1 by bringing the switch 23 of the charge stop unit 30b into the conducting state before starting the drive of the motor 6 so that the charge from the solar cell 1 to the secondary cell 2 is attenuated. Accordingly, the motor drive control unit 5b is capable of restraining the variation of the voltage of the secondary cell which supplies the electric power to the motor 6 during the drive of the motor 6 even when the output voltage of the solar cell 1 varies.

Consequently, the motor drive control unit 5b can rotate the motor 6 normally. The motor drive control unit 5b can prevent the occurrence of erroneous detection when detecting the fact that the motor 6 rotates normally, thereby preventing the motion error which hinders the accurate time measurement. Therefore, the drive control apparatus 100b and the timepiece 200b can drive the motor 6 normally even when the output voltage of the solar cell 1 varies in the same manner as in the first and second embodiments.

The motor drive control unit 5b causes the charge stop unit 30b to intensify the charge of the secondary cell 2 by the electromotive force of the solar cell 1 when the rotation of the motor 6 is detected by the rotation detection unit 51 after having brought the switch 23 into the conducting state.

Accordingly, since the motor drive control unit 5b can intensify the charge of the secondary cell 2 even in a short time, the cell voltage of the secondary cell 2 can be maintained for a long time, and hence the period to allow the motion of the hands can be elongated.

The motor drive control unit 5b also intensifies the charge of the secondary cell 2 when the rotation of the motor is not detected by the rotation detection unit 51 within the period of detection of rotation after having brought the switch 23 into the conducting state. In other words, the motor drive control unit 5b is capable of intensifying the charge of the secondary cell 2 in a period where the correction drive pulse which is not affected by the voltage variations of the secondary cell 2 is generated. Accordingly, since the motor drive control unit 5b can intensify the charge of the secondary cell 2 even in a short time, the cell voltage of the secondary cell 2 can be maintained for a long time, and hence the period to allow the motion of the hands can be elongated.

Also, the motor drive control unit 5b intensifies the charge of the secondary cell 2 when the voltage of the secondary cell 2 is lower than the predetermined threshold value after having brought the switch 23 into the conducting state. Accordingly, since the motor drive control unit 5b can intensify the charge of the secondary cell 2 even in a short time, the cell voltage of the secondary cell 2 can be maintained for a long time, and hence the period to allow the motion of the hands can be elongated.

In the first and second embodiments, the motor drive control unit 5 exercises control to start the charge. However, the invention is not limited thereto, and the charge may be controlled to be intensified as in the third embodiment.

In the first and second embodiments, the motor drive control unit 5 exercises control to stop the charge. However, the invention is not limited thereto, and the charge may be attenuated as in the third embodiment.

Although the embodiments of the invention have been described as far, the invention is not limited to the above-described embodiment, and modifications may be made within the scope of the invention. In the embodiments described above, the mode in which the solar cell 1 is used for the primary power source unit has been described. However, a mode in which other primary power source units are used may also be employed. For example, a mode in which a power generating apparatus configured to convert the kinetic energy into the electric energy by an electromagnetic induction is used in the primary power source unit is also possible.

In the respective embodiments described above, the mode in which the secondary cell 2 is used for the secondary power source unit has been described. However, a mode using a capacitor is also possible. In the embodiments described above, the mode in which the power source line VDD is the VDD ground which indicates the reference potential of the entirety of the timepieces 200, 200a, and 200b has been described. However, the power source line VSS is a VSS ground which indicates the reference potential of the entirety of the timepieces 200, 200a, and 200b is also possible.

In the respective embodiments described above, the mode in which the charge-stop unit 30 (or 30a) shares the function with the charge detection and backflow preventing unit 9 (or the overcharge protecting unit 20a) has been described. However, a mode having a configuration in which the charge is stopped by the charge OFF signal singly is also possible. A mode in which the charge-stop unit 30 (or 30a) includes the charge detection and backflow preventing unit 9 (or 9a) and the overcharge protecting unit 20 (or 20a) is also possible.

In the respective embodiments described above, the mode in which the charge detection and backflow preventing unit 9 (or 9a) is arranged between the cathode terminal of the secondary cell 2 and the cathode terminal of the solar cell 1 has been described. However, a mode in which the charge detection and backflow preventing unit 9 (or 9a) is arranged between the anode terminal of the secondary cell 2 ad the anode terminal of the solar cell 1 is also possible. In other words, when stopping the charge of the secondary cell 2, the charge detection and backflow preventing unit 9 (or 9a) may bring the connection between the anode terminal of the secondary cell 2 and the anode terminal of the solar cell 1 into the non-conducting state.

In the embodiments described above, the respective components such as the oscillation control unit 3, the crystal oscillator 4, the motor drive control units 5 and 5b, the cell voltage detection unit 8, the charge detection and backflow preventing units 9 and 9a, the low consumption mode control unit 10, and the overcharge protecting units 20, 20a, and 20b in the timepieces 200, 200a and 200b may be realized by specific hardware, or may be made up of memories or CPUs (Central Processing Units) and the respective functions described above may be realized by programs. The respective components described above may also be realized by integrated circuits.

The timepieces 200, 200a, and 200b described above each include a computer system. The process steps of the respective components described above are stored in a computer-readable recording medium in a form of the program, and the above-described processes are performed by reading out the program and executing the same by the computer. Here, the term computer-readable recording medium includes a magnetic disk, a magneto-optical disk, a CD-ROM, a DVD-ROM, and a semiconductor memory. It is also possible to distribute the computer program via a communication line to the computer, and cause the computer which receives the distribution to execute the program.

Although the embodiments of the invention have been described with the timepiece apparatus as an example, the invention is not limited to the timepiece apparatus, and may be used effectively in electronic apparatuses each including the solar cell (primary power source), the secondary cell (secondary power source), and the motor.

What is claimed is:

1. A drive control apparatus comprising a motor drive control unit configured to attenuate a charge of a secondary power source unit by an electromotive force of a primary power source unit while a motor is driven in comparison with a case where the motor is not driven.

2. The drive control apparatus according to claim 1, a period when the charge is attenuated by the motor drive control unit is a main drive pulse generating period of the motor.

3. The drive control apparatus according to claim 2, comprising: a rotation detection unit configured to detect the rotation of the motor, wherein
the period when the charge is attenuated by the motor drive control unit includes the main drive pulse generating period of the motor and the period from the start of detection of the rotation of the motor by the rotation detection unit until the rotation of the motor is detected.

4. The drive control apparatus according to claim 1, wherein the intensification of the charge by the motor drive control unit is performed when the rotation is detected by the rotation detection unit.

5. The drive control apparatus according to claim 2, wherein the intensification of the charge by the motor drive control unit is performed when the rotation is detected by the rotation detection unit.

6. The drive control apparatus according to claim 3, wherein the intensification of the charge by the motor drive control unit is performed when the rotation is detected by the rotation detection unit.

7. The drive control apparatus according to claim 1, wherein the intensification of the charge by the motor drive control unit is performed when the rotation of the motor is not detected by the rotation detection unit within a predetermined period.

8. The drive control apparatus according to claim 2, wherein the intensification of the charge by the motor drive control unit is performed when the rotation of the motor is not detected by the rotation detection unit within a predetermined period.

9. The drive control apparatus according to claim 1, comprising a magnetic field detection unit configured to detect a magnetic field received by the drive control apparatus, wherein
the intensification of the charge by the motor drive control unit is performed when the detected magnetic field is stronger than a predetermined magnetic field.

10. The drive control apparatus according to claim 1, comprising a cell voltage detection unit configured to detect the voltage of the secondary power source unit, wherein
the intensification of the charge by the motor drive control unit is performed when the detected voltage is equal to or lower than a predetermined voltage.

11. The drive control apparatus according to claim 1, wherein the intensification of the charge by the motor drive control unit is performed when the drive is translated to a fixed pulse drive.

12. The drive control apparatus according to claim 1 comprising: a charge-stop unit configured to stop the charge of the secondary power source unit, wherein
the motor drive control unit causes the charge-stop unit to stop the charge of the secondary power source unit before driving the motor and gives permission to start the charge after having driven the motor.

13. The drive control apparatus according to claim 12, wherein the charge-stop unit includes an overcharge protecting unit configured to stop the charge of the secondary power source unit when an output potential difference of the primary power source unit is equal to or larger than a predetermined threshold value.

14. The drive control apparatus according to claim 12, wherein the charge-stop unit includes a backflow preventing unit configured to stop the charge of the secondary power source unit when the output potential difference of the primary power source unit is equal to or smaller than an output potential difference of the secondary power source unit.

15. The drive control apparatus according to claim 12, wherein the charge-stop unit brings the connection between an anode terminal of the secondary power source unit and a anode terminal of the primary power source unit or the connection between a cathode terminal of the secondary power source unit and a cathode terminal of the primary power source unit into a non-conducting state when stopping the charge of the secondary power source unit.

16. The drive control apparatus according to claim 12, comprising the backflow preventing unit configured to bring the connection between the anode terminal of the secondary power source unit and the anode terminal of the primary power source unit or the connection between the cathode terminal of the secondary power source unit and the cathode terminal of the primary power source unit into the non-conducting state when the output potential difference of the primary power source unit is equal to or lower than the output potential difference of the secondary power source unit,
wherein the charge-stop unit is configured to bring the connection between the anode terminal of the primary power source unit and the cathode terminal of the primary power source unit into a conducting state when stopping the charge of the secondary power source unit.

17. The drive control unit according to claim 1, wherein the primary power source unit is a solar cell.

18. The drive control apparatus according to claim 1, wherein the motor is a time-of-day motor configured to measure the time.

19. A timepiece apparatus comprising the drive control apparatus according to claim 1.

20. An electric apparatus comprising the drive control apparatus according to claim 1.
